(19) United States
(12) Patent Application Publication
(10) Pub. No.: US 2024/0006931 A1
(43) Pub. Date: Jan. 4, 2024

(54) RESONANT INDUCTIVE RECEIVER SYSTEM

(71) Applicant: Yank Technologies, Inc., Brooklyn, NY (US)

(72) Inventors: Joshua Aaron YANKOWITZ, Brooklyn, NY (US); Vinh CUN, Brooklyn, NY (US); Monika CHAUDHARI, Brooklyn, NY (US)

(73) Assignee: Yank Technologies, Inc., Brooklyn, NY (US)

(21) Appl. No.: 18/252,854

(22) PCT Filed: Nov. 19, 2021
(86) PCT No.: PCT/US2021/072526

§ 371 Date: May 12, 2023

Related U.S. Application Data
(60) Provisional application No. 63/115,996, filed on Nov. 19, 2020.

(51) Int. Cl. H02J 50/90; H02J 50/12; H02J 7/00

(52) U.S. Cl. CPC H02J 50/90; H02J 50/12; H02J 7/0047; H02J 7/0042; H02J 7/00712

(57) ABSTRACT

The disclosed technology provides a resonant inductive receiver integrated in a wireless power receiver accessory such as a phone case and configured to provide power to an electronic device such as a mobile phone. The power to charge the electronic device is received from a pass-through connector coupled to the receiver accessory when a wired charger is plugged into the connector, or received from a wireless power transmitter when a wired charger is not plugged into the connector and the wireless power receiver is proximate to the wireless power transmitter.

### CROSS-REFERENCE TO RELATED APPLICATIONS

This patent document claims priority to and benefit from U.S. Provisional Patent Application No. 63/115,996, entitled “RESONANT INDUCTIVE RECEIVER SYSTEM,” filed on Nov. 19, 2020, which is hereby incorporated by reference in its entirety.

### TECHNICAL FIELD

The present document relates to resonant inductive receivers.

### BACKGROUND

Conventional mobile charging accessories, for example, inductive-based charging receivers embedded within mobile devices, suffer from several limitations including limited charging distance, sensitivity to relative position and orientation with respect to the transmitter/charger, and overheating when charging multiple devices simultaneously. Although resonant inductive charging systems can help overcoming some of the limitations of inductive charging systems, there are challenges to integrating magnetic resonant receivers with mobile electronic devices. There is therefore a need for a wireless power receiver that provides greater flexibility and freedom when charging electronic devices using wireless charging transmitters.

### BRIEF DESCRIPTION OF THE DRAWINGS

FIGS. 1A, 1B, and 1C are representative illustrations of phone cases with embedded magnetic resonant power receivers without pass-through connectors.

FIG. 2 is a representative illustration of a magnetic resonant power receiver embedded in a phone case.

FIG. 3 is a representative block diagram of a magnetic resonant power receiver without a power pass-through connector.

FIG. 4 is a representative block diagram of a magnetic resonant power receiver with a power pass-through connector.

FIG. 5A is representative illustration of first view of a phone case with an embedded magnetic resonant power receiver and a pass-through connector.

FIG. 5B is representative illustration of second view of a phone case with an embedded magnetic resonant power receiver and a pass-through connector.

FIG. 6 is a block diagram that illustrates an example of a computer system in which at least some operations described herein can be implemented.

FIG. 7 is a flowchart that illustrates a process for selectively coupling a charging current to a mobile device.

### DETAILED DESCRIPTION

A resonant inductive wireless power receiver (i.e., charging receiver) is disclosed which can be integrated directly inside an electronic device (e.g., a mobile device) or integrated in a wireless power receiver accessory (e.g., embedded in a phone case for a mobile phone). The disclosed technology includes a wireless charging circuit and a wired charging circuit (e.g., power pass-through circuit). The wireless charging circuit receives power from a wireless power transmitter when the wireless power transmitter is nearby. In some embodiments, the wireless power reception is activated only when a charging cable is not plugged into a pass-through connector. When a charging cable is plugged into the pass-through connector, and is supplying power, a power switch allows the mobile device to be charged by the charging cable (e.g., the wired charging circuit passes surge-protected power from the charging cable to the mobile device via the power switch) and disables the wireless charging circuit. The disclosed technology, in some embodiments, limits the current provided to the mobile device to different current levels based on how far the mobile device is to the wireless power transmitter.

Various embodiments are described throughout the present document. The following description provides specific details for a thorough understanding and an enabling description of these embodiments. One skilled in the art will understand, however, that the disclosed techniques can be practiced without many of these details. Additionally, some well-known structures or functions may not be shown or described in detail, to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

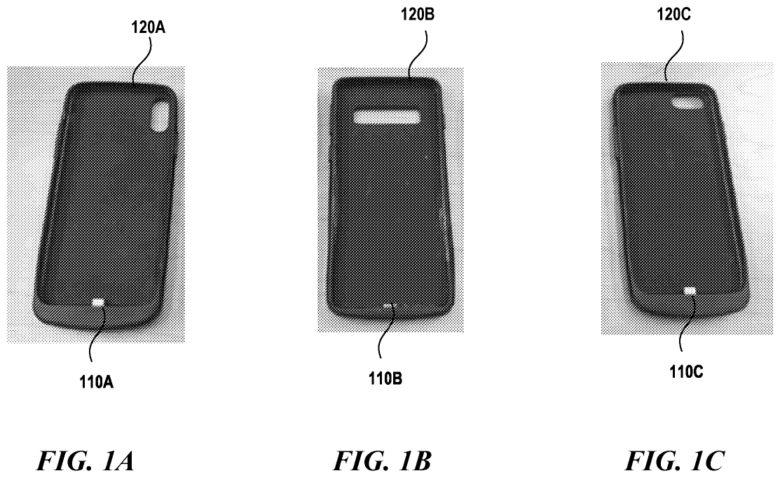

FIGS. 1A, 1B, and 1C are representative illustrations of phone cases 110A, 110B, and 110C with embedded resonant inductive receivers without pass-through connectors. In these representative embodiments, the power charging port of the mobile device (not shown in FIGS. 1A-1C) is plugged into or otherwise coupled to the charging port 110A embedded in phone case 120A, or charging port 110B embedded in phone case 120B, or charging port 110C embedded in phone case 120C when the mobile device is enclosed within any of the phone cases illustrated in FIGS. 1A-1C. Because the power charging port of the mobile device is coupled to the charging port embedded in the phone case, the charging port of the mobile device is not accessible to the device's user when the device is inside the case. For example, the device's user cannot charge the mobile device with another method, e.g., a wall charger, until the user removes the device from the phone case, thereby freeing up the device's charging port.

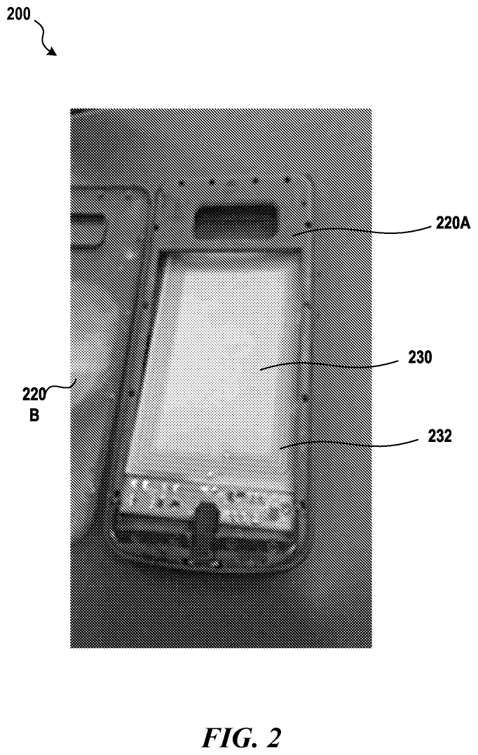

FIG. 2 is a representative illustration of a resonant inductive receiver 230 embedded in a phone case 220A/220B. FIG. 2 shows a back cover 220B of the phone case separated from a front cover 220A of the phone case. The resonant inductive receiver 230 is sandwiched between the front cover 220A and the back cover 220B.

A receiving coil 232 absorbs the magnetic flux of a wireless charging transmitter (wireless charger). In some embodiments, the receiver 230 has a shielding sheet or a high permeability material, and a low a low dissipation factor separation material or layer to isolate the receiver antenna (e.g., receiver coil 232) from the electronic device in the charging case such as from a mobile phone in a phone charging case. This also improves the receiver antenna's intrinsic quality factor ‘Q’. Furthermore, the receiver 230 can also be used a standalone accessory. Rather than embedded into the phone case, the receiver can be sealed with a thin layer of plastic and placed as an accessory between a phone and phone case. In this embodiment, the receiver power plug again occupies the power port of the device.

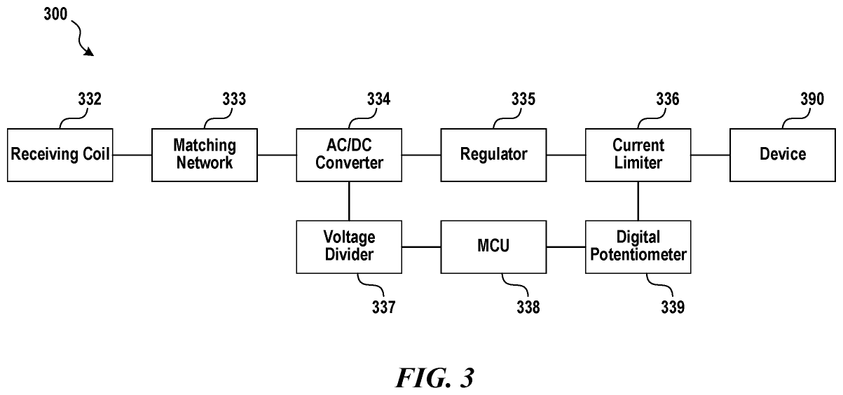

FIG. 3 is a representative block diagram of a resonant inductive receiver system 300 without a power pass-through connector. In this representative embodiment, the power charging port on the electronic device 390 is plugged into a connector embedded in a phone case (e.g., connectors 110A-110C embedded in phone cases 120A-120C in FIG. 1) when the electronic device is inside the phone case. Alternatively, the receiver 300 can also be a resonant inductive receiver placed between a phone and phone case that is again plugged into the power port of the electronic device 390. Consequently, the power charging port of the electronic device is not available while the device is in the phone case or when the electronic device is plugged into a resonant inductive receiver external accessory. Additionally, the resonant inductive receiver, whether embedded in the phone case (e.g., receiver 230 embedded in phone case 220 in FIG. 2) or used as an external accessory placed between a phone and a phone case, is not available to power other electronic devices because it is coupled to the power charging port of the electronic device.

In some implementations, the system 300 can be embedded directly into the mobile device whereby the output of the current limiter can provide power to the device's battery or battery electronics. Portions of the system 300 can be omitted from the integration, for example, the current limiter 336 or regulator 335, allowing for the reuse of power electronics already present within the device.

The system 300 be implemented as an external accessory, e.g., an external case, or can be integrated or embedded within other devices such as wireless communication devices, game controllers, headphones, etc. Wireless communication devices can include handheld mobile devices (e.g., smartphones, portable hotspots, tablets, etc.), laptops, wearables, drones, vehicles with wireless connectivity, head-mounted displays with wireless augmented reality/virtual reality (AR/VR) connectivity, portable gaming consoles, wireless routers, gateways, modems, and other fixed-wireless access devices, wirelessly connected sensors, IoT devices such as wirelessly connected smart home appliances, etc.

A receiving coil 332 (e.g., receiving coil 232 in FIG. 2) is resonant inductively coupled to a wireless charging transmitter and is tuned with a matching network 333. The power received by the receiving coil 332 which is in the form of an alternating current (AC) signal is transformed into a DC signal by an alternating current to direct current (AC/DC) converter 334 (e.g., by a bridge rectifier). The resulting unregulated DC signal is regulated at the operating voltage of the electronic device (e.g., 5 V for mobile devices) by a voltage regulator 335. The regulated voltage is coupled to a current limiter 336 which limits the current based on pre-defined limits based on voltage thresholds measured from the output of the AC/DC converter 334.

Limiting the current using current limiter 336 provides several benefits. For example, for loosely coupled wireless charging systems where the transmitters and receivers are not close together (e.g., as they are in tightly coupled inductive charging systems), it may be desirable to set current limits lower than typical default current limits for the electronic devices so that the electronic devices can charge at the further distances of loosely coupled systems. Additionally, or alternatively, it may be desirable to have a wider range of power delivery thresholds. For example, if the electronic device's default current draw is 500 mA, the device would not charge if less than 500 mA is provided (e.g., the output voltage would be pulled down as the device attempts to draw more current). Furthermore, if there was a second default limit of say 1 A but 750 mA was available, the current draw would be 500 mA. It is therefore beneficial to limit the current to different levels based on the distance or angular positioning between the transmitter/charger and the receivers and/or to limit the current based on the unregulated AC/DC voltage output or the available power to provide a more customized experience. For example, when the wireless power receiver is further away from the wireless power transmitter, current limiter 336 can provide a lower current limit than when the receiver is closer to the transmitter. This allows for a greater degree of flexibility in the wireless charging system.

In some embodiments, resonant inductive receiver 300 monitors the unregulated AC/DC voltage output in real-time, and selects pre-determined thresholds programmed in the microcontroller (MCU) 338. For example, a voltage divider 337 drives a portion of the unregulated AC/DC output voltage from AC/DC converter 334 to the MCU 338 (e.g., via a low output impedance buffer such as an op amp). The MCU 338 selects different resistance values of a digital potentiometer 339 to change the current limit for the device using current limiter 336. In some embodiments, a first distance corresponds to a first output voltage of the AC/DC converter 334 and the second distance corresponds to a second output voltage of the AC/DC converter. If the first distance is larger than the second distance, the first voltage is lower than the second voltage, and the current limit level selected for the first distance is lower than the second current level for the second distance.

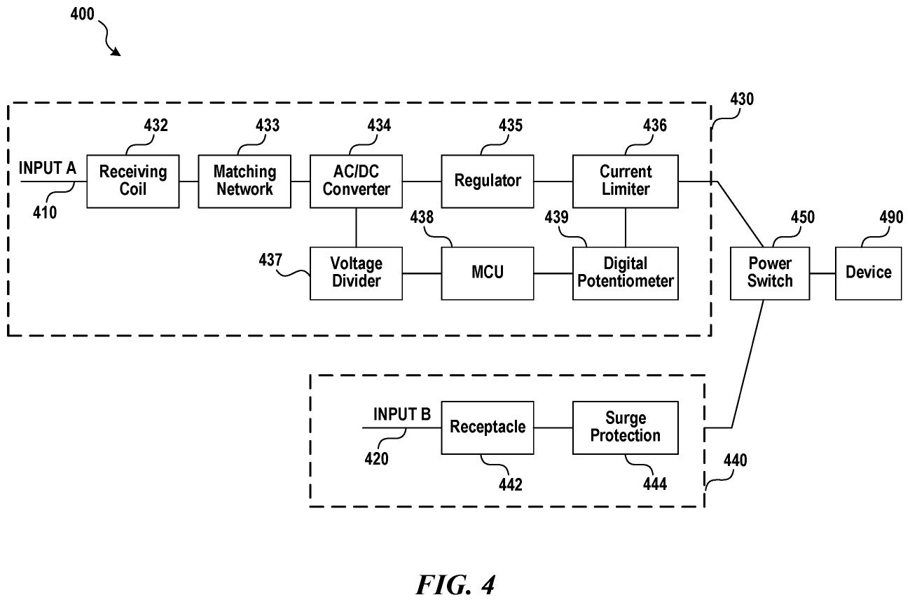

FIG. 4 is a representative block diagram 400 of a resonant inductive receiver with a power pass-through connector. A receiving coil 432 (e.g., receiving coil 232 in FIG. 2) receives wireless power from a wireless charging transmitter (not shown in FIG. 4) (this received wireless power is represented as “input A” 410 in FIG. 4). In this representative embodiment, the wireless power receiver 400 includes an additional power charging port or pass-through connector, e.g., a receptacle connector 442 (e.g., female receptable) in the wireless charging phone case in which the receiver 400 is embedded, that allows the device 490 to receive another power input (represented as “input B” 420 in FIG. 4). The alternative power input from the pass-through connector (receptable 442) goes through a surge protection circuit 444 and is switched onto the device 490 by a power switch 450. The receptacle 442 on the receiver 400 PCB is available for a user to plug a charging cord (or data cord) while the device 490 is inside the phone case. This provides additional user convenience as the user need not remove the mobile device from the phone case to charge the device using a wall charger, for example, when a wireless charging transmitter is not available (or is too far away). The resonant inductive receiver of FIG. 4 is also applicable to other types of devices as described above including tablets, computers, headphones, game controllers, and other wireless communication devices.

In some embodiments, Input A 410 is the default input for wireless charging, while Input B 420 is the input of a wired charger into the receptacle 442. If the Input B 420 is used (e.g., a wired charger is plugged into receptacle 442), receiver 400 disables the wireless charging circuit 430 (i.e., disables one or more of receiving coil 432, matching network 433, AC/DC converter 434, regulator 435, current limiter 436, voltage divider 437, MCU 438, and digital potentiometer 439), and the wired charging circuit 440 powers the device 490. For example, a power switch 450 couples a power signal from either the wireless charging circuit 430 or the wired charging circuit 440 to the device 490 based on whether a wired charger is coupled into the receptable 442. When a wired charger is coupled into the receptable 442, the wired charger charges the device 490 and when a wired charger is not coupled into the receptable 442, the device 490 is charged wirelessly by a wireless charging transmitter as described above in relation to FIG. 3. For example, a push switch can be activated when a charging cable clicks in place to indicate that the charging cable is connected, a change in impedance can indicate that a charging cable is connected, the input voltage of the receptacle can indicate that a charging cable is connected, etc. In some embodiments, the power switch selectively couples a charging current (i.e., power) from the wired charging circuit (i.e., from the receptable 442) if both the charging cable is plugged in and the charging cable is supplying a charging current (i.e., is plugged into a power source). If the charging cable is not connected, or is plugged in but not supplying a charging current, the power switch couples power (i.e., a charging current) to the mobile device from the wireless charging circuit. This power switch action may also be completed by the presence of a voltage applied to the receptacle 442 to indicate to the power switch that a charging cable is connected. In some embodiments, the power switch only couples power from the wireless charging circuit to the mobile device if the wireless charging circuit also detects that a wireless power transmitter is proximate to the mobile device (i.e., the transmitter is nearby and available to supply power to the wireless charging circuit).

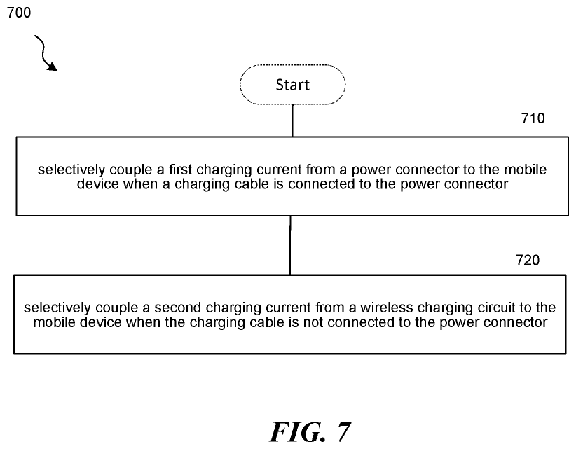

This process of selectively coupling a charging current to the mobile device is illustrated in FIG. 7. For example, at block 710, a first charging current is selectively coupled from a power connector (e.g., the power charging port, pass-through connector, receptacle connector 442 in FIG. 4) to the mobile device when the charging cable is connected to the power connector. At block 720 a second charging current is selectively coupled from a wireless charging circuit (e.g., wireless charging circuit 430 in FIG. 4) to the mobile device when the charging cable is not connected to the power connector.

Turning back to FIG. 4, in some embodiments, both Input A 410 and Input B 420 can simultaneously charge device 490. For example, if the wireless transmitter is far away, Input B can supplement current required to charge device 490 given the limited current that might be available from wireless charging circuit 430 alone. Because the wireless charging circuit 430 would be providing some current to the device 490, the current required from wired charging circuit 440 would be less than that which would be required if wireless charging circuit 430 was not providing any charging current at all. This is beneficial, for example, when a user wants to conserve power drawn from a portable charging device (e.g., a portable battery pack) coupled to the receptacle 442. Additionally, simultaneously charging from a wireless transmitter and a wired source can also provide faster charging particularly when either charging source alone can only provide a limited amount of charging current.

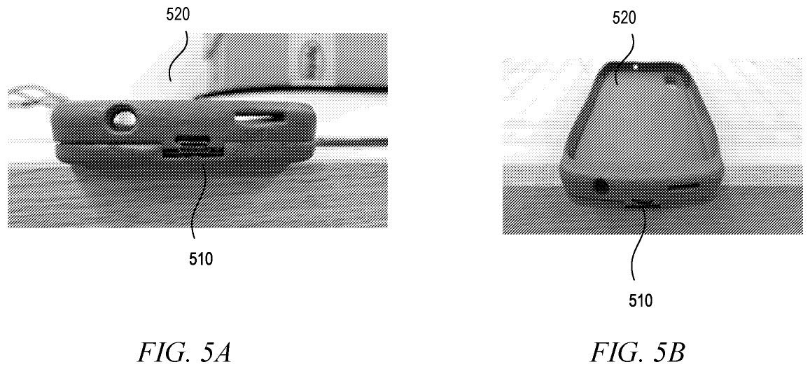

FIGS. 5A and 5B are representative illustrations of a first and second view of a phone case with an embedded resonant inductive receiver and a pass-through connector. A wireless charging circuit (e.g., circuit 430 in FIG. 4) and a wired charging circuit (e.g., circuit 440 in FIG. 4) are integrated inside the phone case 520. The power port of the device is accessible to device's user when the phone is inside the phone case 520 through a pass-through connector 510 (e.g., receptable 442 in FIG. 4) as described above in relation to FIG. 4.

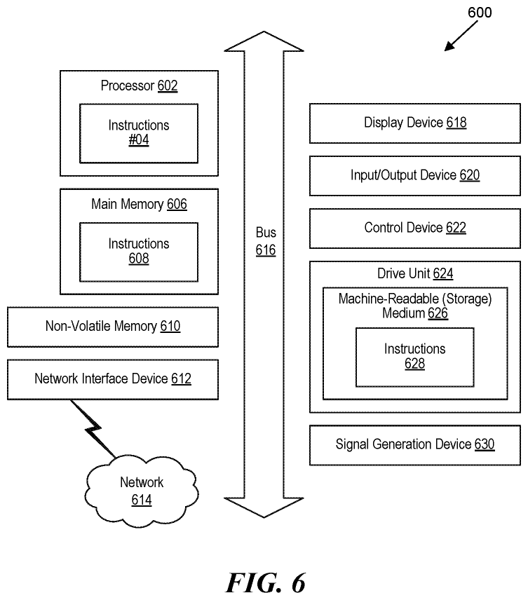

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), ARNR systems (e.g., head-mounted display), or any electronic device capable of executing a set of instructions that specify action(s) to be taken by the computing system 600. In some implementation, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure. It is noted that certain embodiments may include only a portion of the above-described components of the computer system 600. For example, some embodiments may simply use a processor and a memory, while some embodiments may include a communication interface.

A listing of solutions that is preferably implemented by some embodiments can be described using the following clauses.
Clause 1. A wireless power receiver comprising: a wireless charging circuit coupled to a power switch, wherein the wireless charging circuit is configured to receive power from a wireless power transmitter; and, a wired charging circuit coupled to the power switch, wherein the wired charging circuit is configured to receive power from a power connector coupled to the wired charging circuit, wherein the power switch is configured to selectively couple power from the wired charging circuit to a mobile device or from the wireless charging circuit to the mobile device.
Clause 2. The wireless power receiver of clause 1, wherein selectively coupling power from the wired charging circuit to the mobile device is in response to detecting, by the power switch, that a charging cable is coupled to the power connector.
Clause 3. The wireless power receiver of clause 1, wherein selectively coupling power from the wired charging circuit to the mobile device is in response to detecting, by the power switch, that a charging cable is coupled to the power connector and a voltage or current is supplied by the charging cable.
Clause 4. The wireless power receiver of clause 1, wherein selectively coupling power from the wireless charging circuit to the mobile device is in response to detecting, by the power switch, that a charging cable is not coupled to the power connector.
Clause 5. The wireless power receiver of clause 1, wherein selectively coupling power from the wireless charging circuit to the mobile device further comprises determining, by the wireless charging circuit, that the wireless power receiver is proximate to the wireless power transmitter.
Clause 6. The wireless power receiver of clause 1, wherein the wireless charging circuit and the wired charging circuit are embedded in a case comprising a first cover section and a second cover section, wherein the case is adapted to physically protect the mobile device.
Clause 7. The wireless power receiver of clause 1, wherein the wireless charging circuit comprises a current limiter configured to limit a current to the mobile device to a first current level when the mobile device is at a first distance from the wireless power transmitter, and to limit the current to the mobile device to a second current level when the mobile device is at a second distance from the wireless power transmitter.
Clause 8. The wireless power receiver of clause 7, wherein the first current level is lower than the second current level when the first distance is larger than the second distance.
Clause 9. The wireless power receiver of clause 1, wherein the first distance corresponds to a first output voltage of an alternating current to direct current (AC/DC) converter coupled to a receiving coil and the second distance corresponds to a second output voltage of the AC/DC converter, and the first voltage is lower than the second voltage.
Clause 10. The wireless power receiver of clause 1, further comprising: an alternating current to direct current (AC/DC) converter configured to convert an alternating current (AC) voltage received by a receiving coil to a direct current (DC) voltage; a voltage regulator coupled to the AC/DC converter, wherein the voltage regulator is configured to generate a regulated voltage from the DC voltage, and wherein the regulated voltage is at a pre-determined voltage level; and, a current limiter coupled to the voltage regulator, wherein the current limiter is configured to limit a current of the regulated voltage to a current level selected from a plurality of current levels, and wherein the selected current level is determined by a microcontroller based at least in part on a voltage level of the DC voltage.
Clause 11. The wireless power receiver of clause 10, wherein the selected current level is further based on a distance between the wireless power receiver and the wireless power transmitter.
Clause 12. The wireless power receiver of clause 1, further comprising a controller configured to disable the wireless charging circuit when the charging cable is coupled to the power connector.
Clause 13. A wireless power receiver comprising: an alternating current to direct current (AC/DC) converter configured to convert an alternating current (AC) voltage received by a receiving coil to a direct current (DC) voltage; a voltage regulator coupled to the AC/DC converter, wherein the voltage regulator is configured to generate a regulated voltage from the DC voltage, and wherein the regulated voltage is at a pre-determined voltage level; and, a current limiter coupled to the voltage regulator, wherein the current limiter is configured to limit a current of the regulated voltage to a current level selected from a plurality of current levels, and wherein the selected current level is determined by a microcontroller based on a voltage level of the DC voltage or a distance between the wireless power receiver and a wireless power transmitter. In some embodiments, the receiving coil may be a resonant receiving coil that operates on by receiving power wirelessly at a resonance frequency or a resonant frequency band.
Clause 14. A method implemented on a wireless power receiver for supplying power to a mobile device, the method comprising: selectively coupling a first charging current from a power connector to the mobile device when a charging cable is connected to the power connector; and, selectively coupling a second charging current from a wireless charging circuit to the mobile device when the charging cable is not connected to the power connector, wherein the wireless charging circuit is configured to receive a power signal from a wireless power transmitter and generate the second charging current from the received power signal.
Clause 15. The method of clause 14, wherein selectively coupling the first charging current from the power connector to the mobile device when the charging cable is connected to the power connector further comprises determining that a current or a voltage is supplied to the power connector.
Clause 16. The method of clause 14, wherein selectively coupling the second charging current from the wireless charging circuit to the mobile device when the charging cable is not connected to the power connector further comprises determining that the wireless power receiver is proximate to the wireless power transmitter.
Clause 17. The method of clause 14, wherein the wireless power receiver is embedded in a case comprising a first cover section and a second cover section, wherein the case is adapted to physically protect the mobile device.
Clause 18. The method of clause 14, further comprising: limiting, by a current limiter, the second charging current to a first current level when the mobile device is at a first distance from the wireless power transmitter; and, limiting, by the current limiter, the second charging current to a second current level when the mobile device is at a second distance from the wireless power transmitter.
Clause 19. The method of clause 18, wherein the first current level is higher than the second current level when the first distance is larger than the second distance.

### Remarks

The figures and above description provide a brief, general description of a suitable environment in which the invention can be implemented. The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations can perform routines having steps/blocks, or employ systems having blocks, in a different order, and some processes or blocks can be deleted, moved, added, subdivided, combined, or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges.

These and other changes can be made to the invention considering the above Detailed Description. While the above description describes certain examples of the invention, and describes the best mode contemplated, no matter how detailed the above appears in text, the invention can be practiced in many ways. Details of the system can vary considerably in its specific implementation, while still being encompassed by the invention disclosed herein. As noted above, terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A wireless power receiver comprising:
a wireless charging circuit coupled to a power switch, wherein the wireless charging circuit is configured to receive power from a wireless power transmitter; and,
a wired charging circuit coupled to the power switch, wherein the wired charging circuit is configured to receive power from a power connector coupled to the wired charging circuit,
wherein the power switch is configured to selectively couple power from the wired charging circuit to a mobile device or from the wireless charging circuit to the mobile device.

2. The wireless power receiver of claim 1, wherein selectively coupling power from the wired charging circuit to the mobile device is in response to detecting, by the power switch, that a charging cable is coupled to the power connector.

3. The wireless power receiver of claim 1, wherein selectively coupling power from the wired charging circuit to the mobile device is in response to detecting, by the power switch, that a charging cable is coupled to the power connector and a voltage or current is supplied by the charging cable.

4. The wireless power receiver of claim 1, wherein selectively coupling power from the wireless charging circuit to the mobile device is in response to detecting, by the power switch, that a charging cable is not coupled to the power connector.

5. The wireless power receiver of claim 1, wherein selectively coupling power from the wireless charging circuit to the mobile device further comprises determining, by the wireless charging circuit, that the wireless power receiver is proximate to the wireless power transmitter.

6. The wireless power receiver of claim 1, wherein the wireless charging circuit and the wired charging circuit are embedded in a case comprising a first cover section and a second cover section, wherein the case is adapted to physically protect the mobile device.

7. The wireless power receiver of claim 1, wherein the wireless charging circuit comprises a current limiter configured to limit a current to the mobile device to a first current level when the mobile device is at a first distance from the wireless power transmitter, and to limit the current to the mobile device to a second current level when the mobile device is at a second distance from the wireless power transmitter.

8. The wireless power receiver of claim 7, wherein the first current level is lower than the second current level when the first distance is larger than the second distance.

9. The wireless power receiver of claim 7, wherein the first distance corresponds to a first output voltage of an alternating current to direct current (AC/DC) converter coupled to a receiving coil and the second distance corresponds to a second output voltage of the AC/DC converter, and the first voltage is lower than the second voltage.

10. The wireless power receiver of claim 1, further comprising:
an alternating current to direct current (AC/DC) converter configured to convert an alternating current (AC) voltage received by a receiving coil to a direct current (DC) voltage;
a voltage regulator coupled to the AC/DC converter,
wherein the voltage regulator is configured to generate a regulated voltage from the DC voltage, and
wherein the regulated voltage is at a pre-determined voltage level; and,
a current limiter coupled to the voltage regulator,
wherein the current limiter is configured to limit a current of the regulated voltage to a current level selected from a plurality of current levels, and
wherein the selected current level is determined by a microcontroller based at least in part on a voltage level of the DC voltage.

11. The wireless power receiver of claim 10, wherein the selected current level is further based on a distance between the wireless power receiver and the wireless power transmitter.

12. The wireless power receiver of claim 1, further comprising a controller configured to disable the wireless charging circuit when a charging cable is coupled to the power connector.

13. A wireless power receiver comprising:
an alternating current to direct current (AC/DC) converter configured to convert an alternating current (AC) voltage received by a receiving coil to a direct current (DC) voltage;
a voltage regulator coupled to the AC/DC converter,
wherein the voltage regulator is configured to generate a regulated voltage from the DC voltage, and
wherein the regulated voltage is at a pre-determined voltage level; and,
a current limiter coupled to the voltage regulator,
wherein the current limiter is configured to limit a current of the regulated voltage to a current level selected from a plurality of current levels, and
wherein the selected current level is determined by a microcontroller based on a voltage level of the DC voltage or a distance between the wireless power receiver and a wireless power transmitter.

14. The wireless power receiver of claim 13, wherein the selected current level is further based on a distance between the wireless power receiver and the wireless power transmitter.

15. A method implemented on a wireless power receiver for supplying power to a mobile device, the method comprising:
selectively coupling a first charging current from a power connector to the mobile device when a charging cable is connected to the power connector; and,
selectively coupling a second charging current from a wireless charging circuit to the mobile device when the charging cable is not connected to the power connector,
wherein the wireless charging circuit is configured to receive a power signal from a wireless power transmitter and generate the second charging current from the received power signal.

16. The method of claim 15, wherein selectively coupling the first charging current from the power connector to the mobile device when the charging cable is connected to the power connector further comprises determining that a current or a voltage is supplied to the power connector.

17. The method of claim 15, wherein selectively coupling the second charging current from the wireless charging circuit to the mobile device when the charging cable is not connected to the power connector further comprises determining that the wireless power receiver is proximate to the wireless power transmitter.

18. The method of claim 15, wherein the wireless power receiver is embedded in a case comprising a first cover section and a second cover section, wherein the case is adapted to physically protect the mobile device.

19. The method of claim 15, further comprising:
limiting, by a current limiter, the second charging current to a first current level when the mobile device is at a first distance from the wireless power transmitter; and,
limiting, by the current limiter, the second charging current to a second current level when the mobile device is at a second distance from the wireless power transmitter.

20. The method of claim 19, wherein the first current level is higher than the second current level when the first distance is larger than the second distance.

21. (canceled)
